(19) United States
(12) Patent Application Publication
(10) Pub. No.: US 2008/0070687 A1
(43) Pub. Date: Mar. 20, 2008

(54) Slot machines and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/725,537

(22) Filed: Mar. 20, 2007

Related U.S. Application Data
(60) Provisional application No. 60/842,380, filed on Sep. 6, 2006.

(51) Int. Cl. G06F 19/00

(52) U.S. Cl. 463/41

(57) ABSTRACT

A slot machine is connected so as to establish communication with a management server storing data of a plurality of players. The slot machine has a liquid crystal display displaying the data of the players, and an external connecting terminal connectable to a cellular phone. A slot machine controller identifies the player by a connection with the cellular phone via the external connecting terminal, and receives data associated with the identified player from the management server, and then displays the received data on the display.

### BACKGROUND OF THE INVENTION

1. Field of the Invention

The present invention relates to slot machines and a game control method thereof.

2. Related Art

The networking of slot machines has been proposed in recent years. For example, WO2003/090886 (PCT/US2003/010969), or Japanese Unexamined Patent Application Publication No. 2005-523668, discloses a networked computerized game system, and in particular, a technique concerned with security. Furthermore, WO2004/013820 (PCT/US2003/023872), or Japanese Unexamined Patent Application Publication No. 2005-534417, discloses the sharing of data indicating a degree of courtesy over a network.

The present invention provides new slot machines enhancing convenience by links between cellular phones and the slot machines.

### SUMMARY OF THE INVENTION

According to a first aspect of the present invention, a slot machine is connected so as to establish communication with a management server storing data of a plurality of players. The slot machine includes a display displaying the data, a connecting terminal connectable to a player's cellular phone, and a game controller. The game controller identifies the player by a connection to the cellular phone via the connecting terminal, and receives data associated with the identified player from the management server, and then displays the received data on the display.

This slot machine is connectable to the cellular phone, and identifies the player from an individual identification number of the cellular phone, and then receives the data of the identified player from the management server. The received data can be displayed on the display of the slot machine.

According to a second aspect of the present invention, the display displays an instruction input image corresponding to instructions inputted by a player. The slot machine further includes a touch panel disposed on a front surface of the display. The touch panel is capable of detecting the contact of the player, and outputting a detection signal indicating the contact position during contact detection. The game controller controls a representation on the display based on an instruction associated with the instruction input image, when a detection signal indicating a contact position corresponding to a display position of the instruction input image on the display is outputted from the touch panel.

In this slot machine, the representation on the display can be controlled by the player's operation of the touch panel disposed on the display.

According to a third aspect of the present invention, the cellular phone has an operating part accepting input from a player, and game controller which controls the representation on the display, based on a player's operation of the operating part.

In this slot machine, the representation on the display can be controlled by the player's operation of the operating part of the cellular phone.

According to a fourth aspect of the present invention, the game controller accepts voice data input from the player via the connected cellular phone, and recognizes the accepted voice data according to the voice data input, and converts the recognized voice data to character data, and then displays the converted character data on the display.

In this slot machine, the game controller converts the voice data from the player (for example, a response over the phone), and displays the converted data on the display. That is, for example, if someone calls the player performing a game with the slot machine, the contents of the call can be displayed on the display.

According to a fifth aspect of the present invention, a slot machine connected so as to establish communication with a management server storing data of a plurality of players. The slot machine includes a display displaying the data, an insertion slot into which an individual identification card of a player can be inserted, and a game controller. The game controller identifies the player by insertion of the individual identification card into the insertion slot, and receives data associated with the identified player from the management server, and then displays the received data on the display.

In this slot machine, the player may be identified by the individual identification card of the player, instead of the cellular phone.

According to a sixth aspect of the present invention, the individual identification card is an SIM card.

In this slot machine, the SIM card is used to identify the player.

### BRIEF DESCRIPTION OF THE DRAWINGS

FIG. 1 is a block diagram showing the relationship between slot machines according to a preferred embodiment of the present invention and cellular phones or the like;

FIG. 2 is a perspective view showing the appearance of the slot machine in the preferred embodiment;

FIG. 3 is a perspective view showing an example of a connecting surface of the slot machine in the preferred embodiment;

FIG. 4 is a perspective view showing another example of the connecting surface of the slot machine in the preferred embodiment;

FIG. 5 is an enlarged front view showing an enlarged display area of the slot machine in the preferred embodiment;

FIG. 6 is a perspective view when viewed from the back side of the contour (of the construction) of a liquid crystal display of the slot machine in the preferred embodiment;

FIG. 7 is an exploded perspective view showing the construction of part of the liquid crystal display shown in FIG. 6;

FIG. 8 is a block diagram showing the electrical configuration of a controller of the slot machine in the preferred embodiment;

FIG. 9 is a diagram showing the configuration of member data storage table stored in management server;

FIGS. 10 and 11 are examples of the liquid crystal display of the slot machine in the preferred embodiment;

FIG. 12 is a diagram illustrating a situation in which a member registration is performed by a cellular phone;

FIGS. 13 to 16 show examples of the liquid crystal display of the slot machine in the preferred embodiment;

FIG. 17 is a flow chart showing a main process flow of the slot machine in the preferred embodiment;

FIG. 18 is a flow chart showing a player discrimination process flow of the slot machine in the preferred embodiment;

FIG. 19 is a flow chart showing a game control process flow of the slot machine in the preferred embodiment;

FIG. 20 is a flow chart showing the incoming call interrupt process flow of the slot machine in the preferred embodiment; and

FIG. 21 is a flow chart showing the conversation process flow of the slot machine in the preferred embodiment.

### DETAILED DESCRIPTION OF THE INVENTION

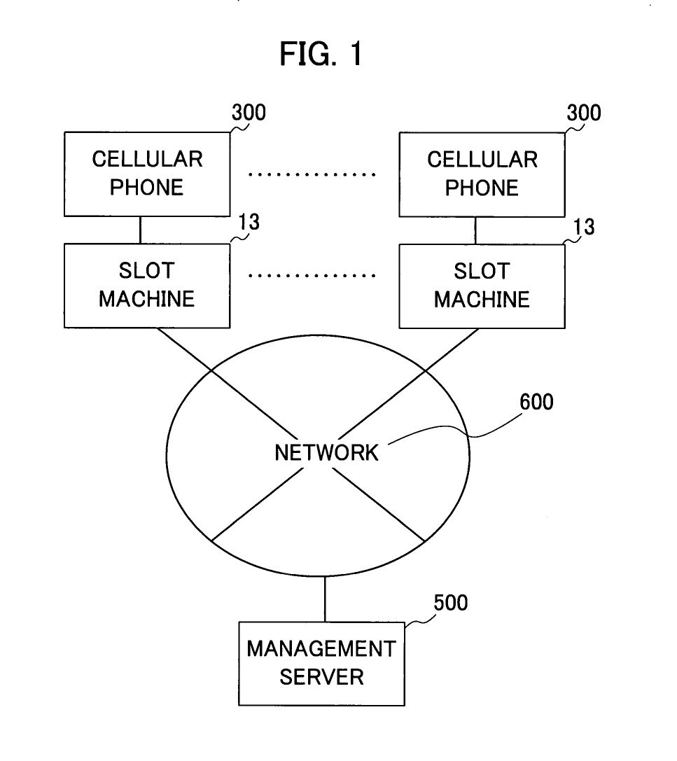

The construction of the slot machine 13 of a preferred embodiment of the present invention will now be described with reference to FIG. 1.

FIG. 1 is a block diagram showing the relationship between the slot machines 13 of the preferred embodiment and cellular phones 300 or the like.

In the block diagram of FIG. 1, a plurality of the slot machines 13 are connected to the cellular phones 300, respectively. The slot machines 13 are connected to a management server 500 over the network 600.

The respective slot machines 13 are slot machines enabling players to perform a basic game. The respective cellular phones 300 have individual serial numbers. The management server 500 manages member data of the players at a gaming facility, such as a casino, by the individual serial numbers of the cellular phones 300.

Here, each of the slot machines 13 can receive, through the cellular phone 300 connection, the member data associated with the serial number of the cellular phone 300 from the management server 500, and the slot machine 13 executes a slot game while referring to the member data received.

Thus, the slot machines 13 of the present invention manage the member data of the players and execute slot games by using cellular phones generally used among people today. It is therefore capable of enhancing convenience when identifying the member.

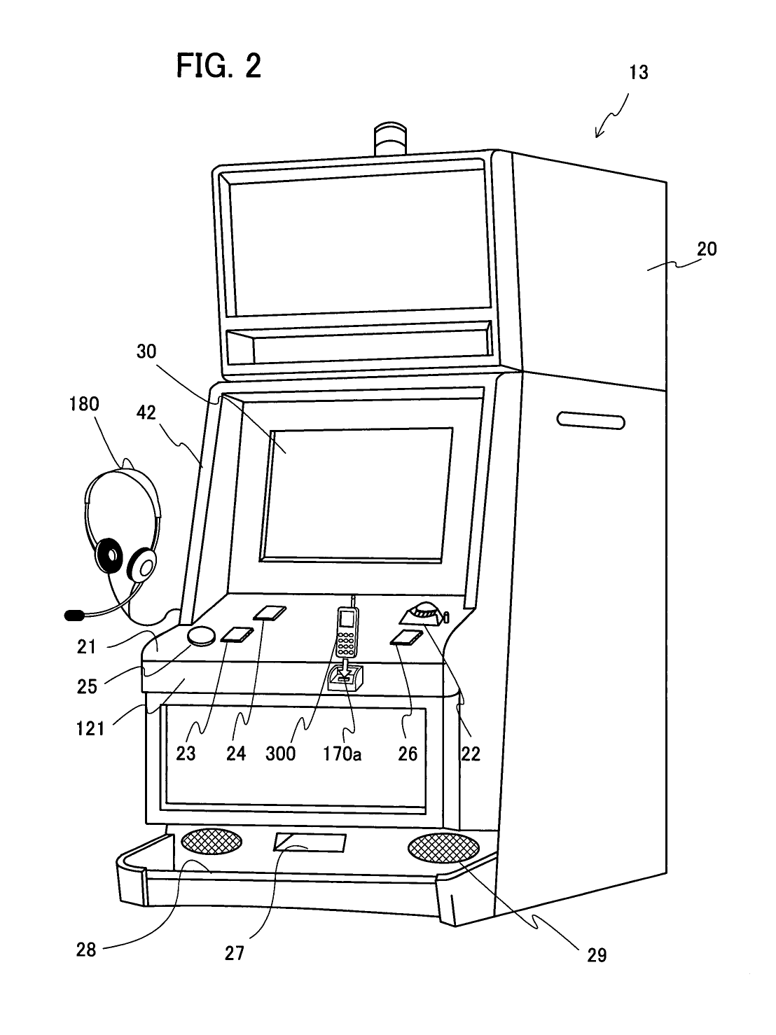

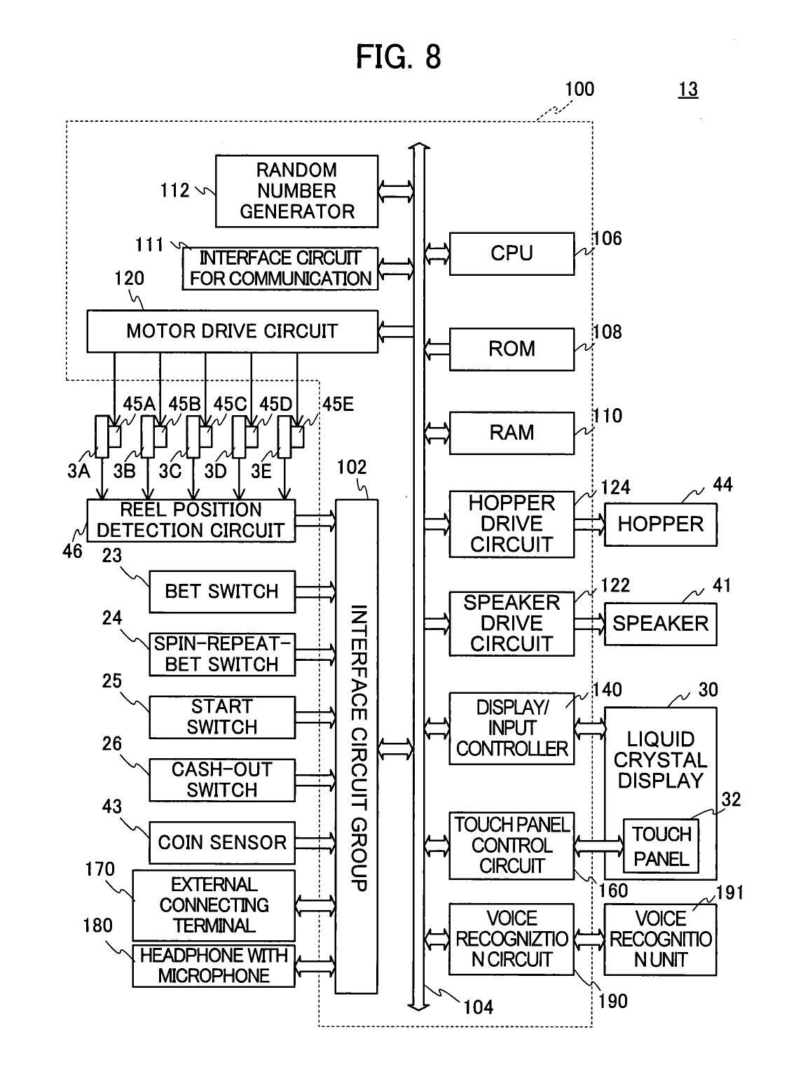

FIG. 2 is a perspective view showing the appearance of the slot machine 13 in the preferred embodiment. The slot machine 13 includes a cabinet 20 and a main door 42. The cabinet 20 has a surface opening toward the player. The cabinet 20 houses various components including a controller 100 (refer to FIG. 8) for electrically controlling the slot machine 13, and a hopper 44 (refer to FIG. 8) for controlling the insertion, storage, and payout of coins (game media), and the like. The game media are not limited to coins. For example, they may be medals, tokens, electronic money, or electronic information (credits) equivalent to these.

The main door 42 is a member with which the interior of the cabinet 20 is covered so as not to be exposed to the outside. A liquid crystal display 30 is disposed at substantially the center of the main door 42. A headphone 180 with a microphone is disposed on the left of the main door 42.

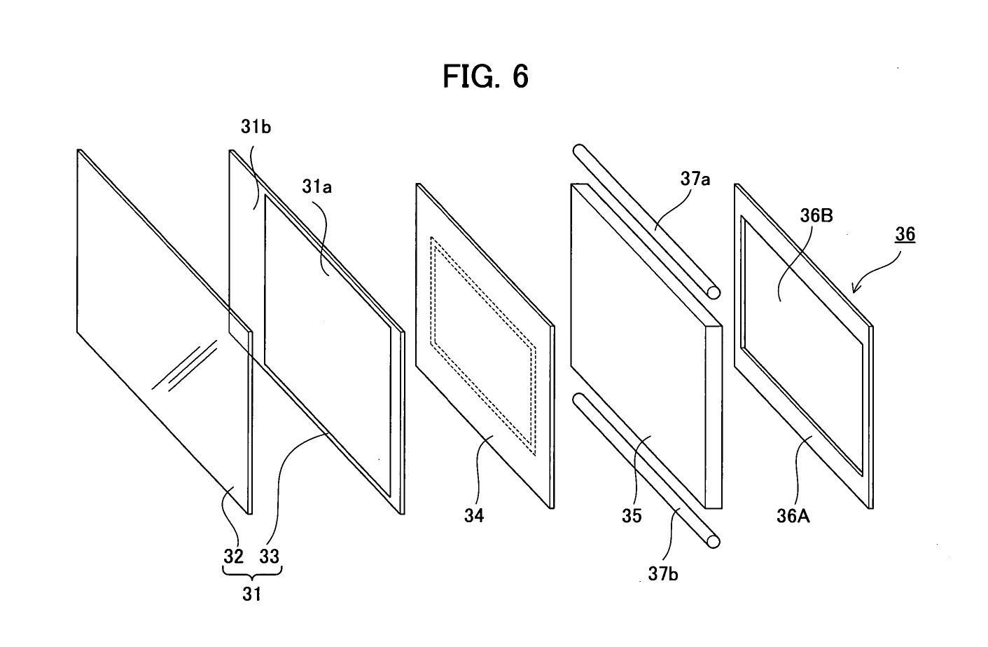

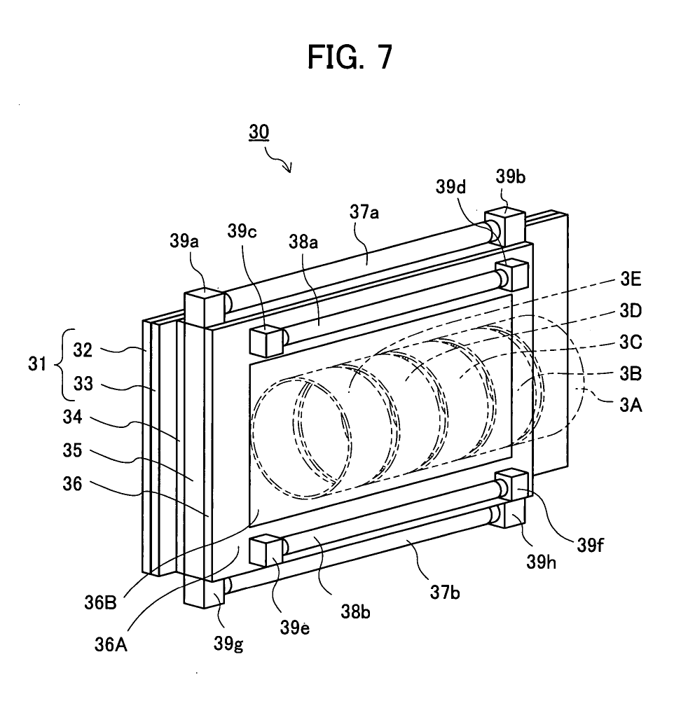

The liquid crystal display 30 provides a variety of images related to games, including produced images and the like. The player advances the game while observing a variety of images displayed on the liquid crystal display 30. The liquid crystal display 30 includes a transparent liquid crystal panel 34 (refer to FIGS. 6 and 7). The transparent liquid crystal panel 34 can be brought partly or entirely into its transparent or non-transparent state, and can also display a variety of images. The construction of the liquid crystal display 30 will be described in detail later.

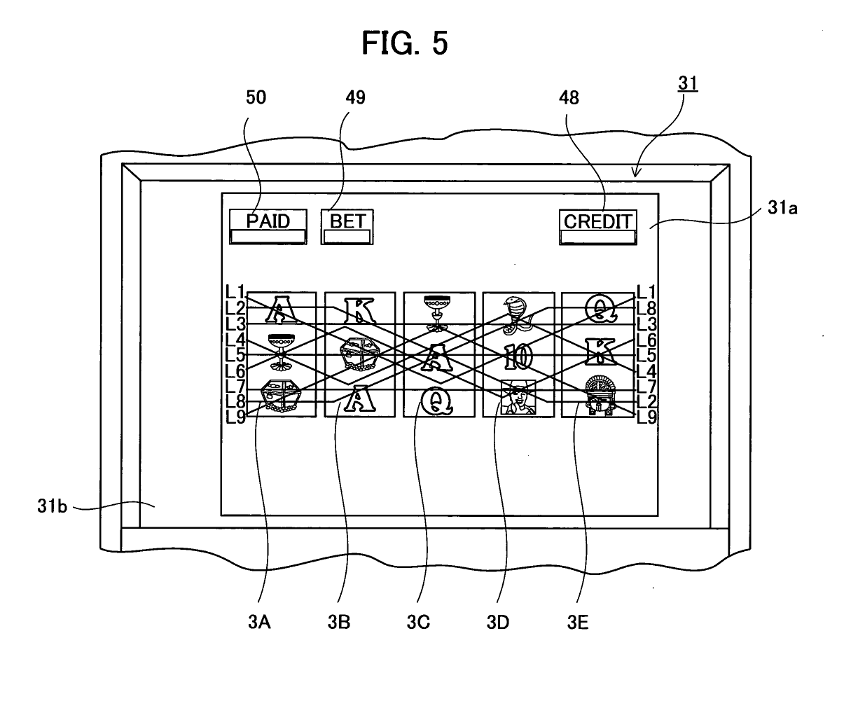

On the back side of the liquid crystal display 30, five mechanical reels 3A, 3B, 3C, 3D, and 3E (refer to FIG. 5), each having a plurality of kinds of symbols on its outer peripheral surface, are rotatably laterally aligned. The mechanical reels 3A to 3E are constructed as a plurality of symbol displaying means, together with stepping motors 45A, 45B, 45C, 45D, and 45E (refer to FIG. 8) to be described later. The mechanical reels 3A to 3E have on their respective outer peripheral surfaces a plurality of kinds of symbols necessary for a basic game. These symbols of the mechanical reels 3A to 3E are made visible when the transparent liquid crystal panel 34 is in its transparent state.

A substantially horizontal operating part 21 is disposed below the liquid crystal display 30. Disposed on the right side of the operating part 21 is a coin slot 22 through which a number of coins are inserted into the slot machine 13. On the other hand, disposed on the left side of the operating part 21 are a BET switch 23 and a spin-repeat-bet switch 24. The BET switch 23 is used to choose the number of coins as game media to be bet on lines L1, L2, L3, L4, L5, L6, L7, L8, and L9 for awarding nine prizes to be described later (hereinafter referred to simply as “winning lines”), any one of which can be decided so as to activate, and the activated prize is awarded. The spin-repeat-bet switch 24 is used to repeat the game without changing the number of coins bet on the winning lines in the last game. The number of coins bet on the winning lines can be selected by pushing the BET switch 23 or the spin-repeat-bet switch 24.

In the operating part 21, a start switch 25 for accepting, per game, the player's operation of starting the basic game is disposed on the left side of the BET switch 23. Pushing either the start switch 25 or the spin-repeat-bet switch 24 triggers the start of the game, and the above-mentioned five mechanical reels 3A to 3E are then rotated.

Also in the operating part 21, a cash-out switch 26 is disposed in the vicinity of the coin slot 22. When the player pushes the cash-out switch 26, the inserted coins can be paid out from a coin dispensing slot 27. The dispensed coins can be collected on a coin tray 28. Sound permeable openings 29, through which sound effects outputted from a speaker 41 (refer to FIG. 8), housed within the cabinet 20, are propagated to the outside of the cabinet 20, and disposed on the right and left sides, with the coin discharge slot 27 interposed therebetween above the coin tray 28.

A connecting surface 121 extending substantially vertically is disposed below the operating part 21. A cellular phone connecting holder 170a, configured so as to be connectable to the cellular phone 300 of the player, is disposed on the right side of the connecting surface 121.

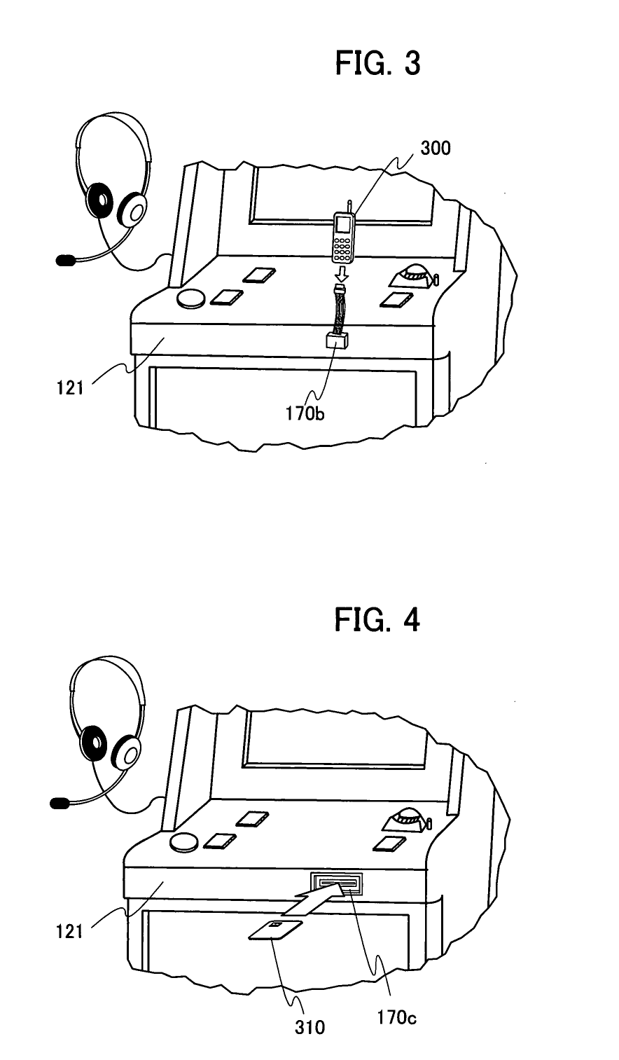

FIGS. 3 and 4 are perspective views showing the connecting surface 121.

Referring to FIG. 3, a cellular phone connecting cable 170b configured so as to be connectable to the cellular phone 300 of the player is disposed in the connecting surface 121. Each of the slot machines 13 in the present invention is required to enable the slot machine 13 and the cellular phone 300 to be connected to each other. Therefore, any means other than cellular phone connecting holder 170a or cellular phone connecting cable 170b may be employed.

The connection to the cellular phone 300 is for the purpose of increasing the convenience when identifying the member. Alternatively, as shown in FIG. 4, a card slot 170c may be provided so that an identification card 310 can be inserted therein. The identification card 310 may be a card having an individual serial number, such as an SIM card. Specifically, the SIM (subscriber identifying module) card is a card storing contractor information, which is used to identify the user by being into the cellular phones possessed and carried by most players. Hence, the present invention is capable of increasing convenience when identifying the member by employing the SIM cards that the players usually carry.

FIG. 5 shows an enlarged display area of slot machine 13. The liquid crystal display 30 of the slot machine 13 includes a front panel 31 and a transparent liquid crystal panel 34 (refer to FIGS. 6 and 7), which is disposed on the back surface of the front panel 31. The front panel 31 can be constructed by incorporating a transparent display surface 31a and a symbol forming area 31b where a symbol can be formed. Image information displayed on the transparent liquid crystal panel 34 disposed on the back surface of the front panel 31 can be observed through the display surface 31a of the front panel 31. On the other hand, when the area of the transparent liquid crystal panel 34 is in a transparent state, the symbols on the five mechanical reels 3A to 3E arranged to the rear of the transparent liquid crystal panel 34 can be observed through the display surface 31a. Display parts 48 to 50 are disposed above the mechanical reels 3A to 3E.

Referring to FIG. 5, the slot machine 13 has the lines L1 to L9 for awarding the nine prizes. These lines L1 to L9 extend so as to pass through a symbol of each of the mechanical reels 3A to 3E, when all of the rotations of the mechanical reels 3A to 3E come to a stop.

For example, a one-push operation of the BET switch 23 activates the line L3 for awarding a third prize, the line L5 for awarding a fifth prize, and the line L7 for awarding a seventh prize, and also takes subtracts one coin as a credit medal.

A two-push operation of the BET switch 23 activates, for example, the line L1 for awarding a first prize, the line L4 for awarding a fourth prize, and the line L8 for awarding an eighth prize, in addition to the above-mentioned three lines, and also takes subtracts two coins as credit medals.

A three-push operation of the BET switch 23 activates, for example, the line L2 for awarding a second prize, the line L6 for awarding a sixth prize, and the line L9 for awarding a ninth prize, in addition to the above-mentioned six lines, and also takes subtracts three coins as credit medals.

A game executable in the present embodiment is the basic game to align symbols on the winning lines. If a number of predetermined symbols are aligned on the winning lines, the player receives a prize.

A display part 48 displays the number of credits of coins stored in the slot machine 13. A display part 49 displays the number of BETs, namely the number of coins bet on the winning lines. A display part 50 displays the coin payout amount when a combination for awarding a prize is displayed on the winning lines. The display parts 48 to 50 may be displayed with images on the transparent liquid crystal panel 34. Alternatively, a seven-segment indicator may be included.

FIGS. 6 and 7 show the construction of the liquid crystal display 30 of the slot machine 13. The liquid crystal display 30 displays game images and the like, related to the basic game. Therefore, the liquid crystal display 30 is constructed of the front panel 31 including a touch panel 32 and a display board 33, the transparent liquid crystal panel 34, a light guide plate 35, a reflecting film 36, fluorescent lamps 37a, 37b, 38a, and 38b being so-called white light sources, lamp holders 39a, 39b, 39c, 39d, 39e, 39f, 39g, and 39h, and a table carrier package (TCP) mounting thereon ICs for driving the transparent liquid crystal panel. The TCP, not being shown in FIGS. 6 and 7, is constructed of a flexible substrate (not shown) connected to a terminal part of the transparent liquid crystal panel 34.

The liquid crystal display 30 is disposed in front of the display areas of the mechanical reels 3A to 3E (in front of the display surface 31a), so as to crossover the mechanical reels 3A to 3E. A predetermined spacing is provided between the mechanical reels 3A to 3E, and the liquid crystal display 30.

The touch panel 32 is formed of a transparent member. The display board 33 is formed of a transparent member, and a symbol or the like can be formed at a predetermined position on the display board 33. In this case, the area where the symbol or the like is formed on the display board 33 corresponds to the symbol forming area 31b on the front panel 31. On the other hand, the area in which neither the symbol nor the like is formed on the display board 33 corresponds to the display surface 31a on the front panel 31 (refer to FIG. 4). Alternatively, the entire surface of the front panel 31 may be the display surface 31a, without forming the symbol forming area 31b on the front panel 31. In this case, the display board 33 may be omitted.

The transparent liquid crystal panel 34 can be achieved by sealing liquid crystal in a clearance part between a transparent substrate such as a glass plate with a thin film transistor layer formed thereon, and another transparent substrate opposed thereto. The display mode of the transparent liquid crystal panel 34 is set to normal white. The term “normal white” means a mode in which a white display is provided with no liquid crystal being driven (the light transmitted to the display surface side can be observed from the outside). By employing the transparent liquid crystal panel 34 set to the normal white, the player can continue the game because the variable displays and the stop displays of the respective symbols on the mechanical reels 3A to 3E can be observed in the event that the liquid crystal cannot be driven. That is, even in that event, it is possible to perform a game comprised mainly of a rearrangement of the symbols on the mechanical reels 3A to 3E.

The light guide plate 35, which guides the light from the fluorescent lamps 37a and 37b to the transparent liquid crystal panel 34 (in other words, illuminates the transparent liquid crystal panel 34), is disposed on the back side of the transparent liquid crystal panel 34, and formed of a transparent member such as acrylic resin (with a light guiding function) having a thickness of about 2 cm.

The reflecting film 36 can be obtained by forming, for example, a silver deposition film on a white polyester film or an aluminium thin film, and reflects the light introduced in the light guide plate 35 toward the front side of the light guide plate 35. The reflecting film 36 is constructed of a reflecting area 36A and a non-reflecting area (a permeable area) 36B. The non-reflecting area 36B is formed of a transparent material and disposed in an area including a part of the front panel 31 which covers the front parts of the mechanical reels 3A to 3E.

The fluorescent lamps 37a and 37b are disposed along the upper end and the lower end of the light guide plate 35, respectively, and both ends thereof are supported by lamp holders 39a and 39b, and lamp holders 39g and 39h, respectively. The light irradiated from the fluorescent lamps 37a and 37b is reflected from the reflecting area 36A of the reflecting film 36, and irradiates the transparent liquid crystal panel 34. On the other hand, the fluorescent lamps 38a and 38b are disposed at upper and lower positions of the back side of the reflecting film 36, respectively, and directed to the mechanical reels 3A to 3E. Both ends of the fluorescent lamps 38a and 38b are supported by lamp holders 39c and 39d, and lamp holders 39e and 39f, respectively. The light emitted from the fluorescent lamps 38a and 38b is reflected from the surfaces of the mechanical reels 3A to 3E to the non-reflecting area 36B, and illuminates the transparent liquid crystal panel 34. Thus, in the liquid crystal display 30, the light irradiated from the fluorescent lamps 37a and 37b, reflected from the reflecting area 36A of the reflecting film 36, and the light irradiated from the fluorescent lamps 38a and 38b, reflected from the surfaces of the mechanical reels 3A to 3E to the non-reflecting area 36B, illuminate the transparent liquid crystal panel 34. Hence, the area of the liquid crystal display 30 corresponding to the non-reflecting area 36B of the reflecting film 36 is an area to be switched between a transparent state and a non-transparent state, depending on whether the liquid crystal is driven or not. On the other hand, the area of the liquid crystal display 30, corresponding to the reflecting area 36A of the reflecting film 36, is brought into the non-transparent state irrespective of whether the liquid crystal is driven or not.

Although in the slot machine 13, only a partial area of the display surface of the liquid crystal display 30 is switched between the transparent state and the non-transparent state, the entire area of the display surface of the liquid crystal display 30 may be switched between the transparent state and the non-transparent state. In this case, the reflecting film 36 may be entirely formed as the non-reflecting area 36B, or the reflecting film 36 may be omitted.

FIG. 8 is a block diagram showing the electrical configuration of the controller 100 of the slot machine 13. The controller 100 is a microcomputer provided with an interface circuit group 102, an input-output bus 104, a CPU 106, a ROM 108, a RAM 110, an interface circuit 111 for communication, a random number generator 112, a motor drive circuit 120, a speaker drive circuit 122, a hopper drive circuit 124, a display/input controller 140, and a touch panel control circuit 160.

The interface circuit group 102 is connected to the input-output bus 104 performing input and output of data signals or address signals with respect to the CPU 106.

A start switch 25 is connected to the interface circuit group 102. A start signal outputted from the start switch 25 is converted to a predetermined signal by the interface circuit group 102, and then supplied to the input-output bus 104.

The BET switch 23, the spin-repeat-bet switch 24, and the cash-out switch 26 are also connected to the interface circuit group 102. Switching signals outputted from the switches 23, 24, and 26, respectively, are also supplied to the interface circuit group 102, and converted to predetermined signals by the interface circuit group 102, respectively, and then supplied to the input-output bus 104.

A coin sensor 43 is also connected to the interface circuit group 102. The coin sensor 43 is a sensor for detecting coins inserted into the coin slot 22, and provided in relation to the coin slot 22. A sensing signal outputted from the coin sensor 43 is also supplied to the interface circuit group 102, and converted to a predetermined signal by the interface circuit group 102, and then supplied to the input-output bus 104.

A reel position detection circuit 46 is also connected to the interface circuit group 102. The reel position detection circuit 46 is a circuit for detecting the rotational positions of the mechanical reels 3A to 3E, based on pulse signals from a reel rotational position sensor (not shown). The detection signals from the reel position detection circuit 46 are also supplied to the interface circuit group 102, and converted to predetermined signals by the interface circuit group 102, and then supplied to the input-output bus 104.

An external connecting terminal 170 is also connected to the interface circuit group 102. For example, the external connecting terminal 170 is attached to the cellular phone connecting holder 170a, the cellular phone connecting cable 170b, the card slot 170c, or the like. The connection of the external connecting terminal 170 to the cellular phone 300 permits communication between the cellular phone 300 and the slot machine 13.

The headphones 180 with the microphone are also connected to the interface circuit group 102. The headphones 180 with the microphone output the voice of the caller to the player, and receives the voice of the player in a communication process described later.

The ROM 108 and the RAM 110 are connected to the input-output bus 104.

Upon acceptance of the start operation of the basic game through the start switch 25, the CPU 106 reads a basic game program to execute the basic game. The basic game program is programmed as follows. That is, all of the stepping motors 45A to 45E are driven to rotate all of the mechanical reels 3A to 3E, so as to start the scrolling of the symbols on the reels 3A to 3E. Thereafter, the drives to the stepping motors 45A to 45E are stopped to stop the rotations of all of the mechanical reels 3A to 3E, so as to rearrange the reels 3A to 3E. If a combination of symbols stopped at this time is displayed on the winning lines, and the combination corresponds to a specific combination for which a prize is awarded, a number of coins associated with the specific combination are paid out.

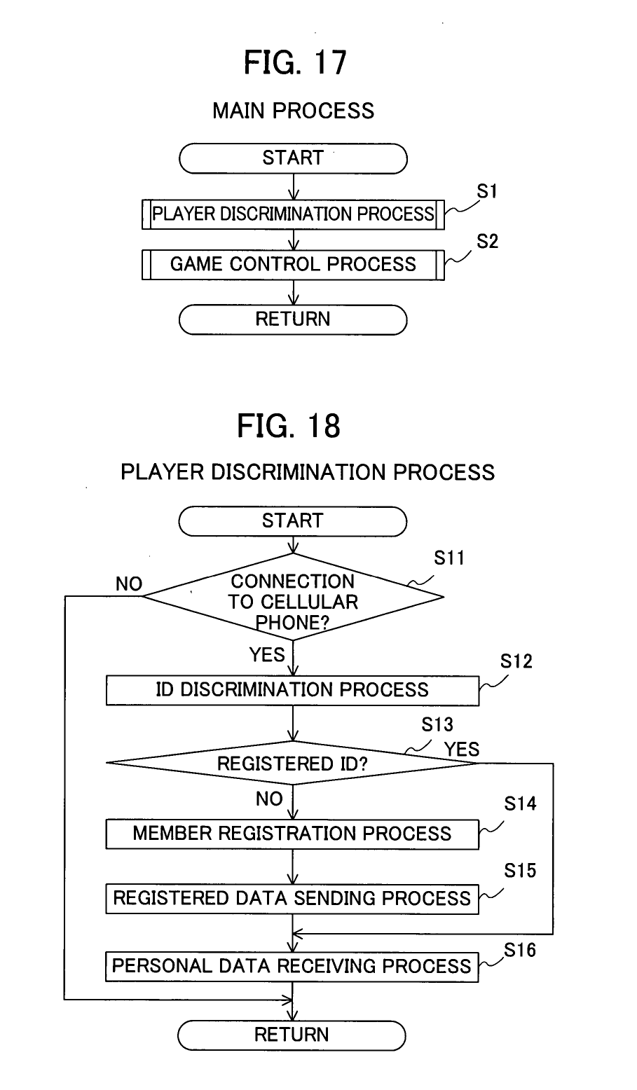

The ROM 108 stores a control program for regulating and controlling the slot machine 13, a program for executing routines as shown in FIGS. 17 to 21 (hereinafter referred to as a “routine execution program”), and initial data for executing the control program, and various data tables used in a determination process. The routine execution program includes the above-mentioned basic game program and the like. The RAM 110 temporarily stores the values of flags and variables, and the like used in the control program.

The interface circuit 111 for communication is also connected to the input-output bus 104. The interface circuit 111 for communication is a circuit for communication with the management server 500 or the like, over the network 600 including a variety of networks.

The random number generator 112 for generating random numbers is also connected to the input-output bus 104. The random number generator 112 generates random numbers included in a certain range of numerical values, for example, “0” to “65535 (2¹⁶-1).” Alternatively, the random numbers may be generated by mathematical (calculations) processing of the CPU 106.

The motor drive circuit 120 for driving the stepping motors 45A to 45E is also connected to the input-output bus 104. In response to the occurrence of a predetermined event, the CPU 106 controls the operations of the stepping motors 45A to 45E via the motor drive circuit 120.

The speaker drive circuit 122 for driving the speaker 41 is also connected to the input-output bus 104. The CPU 106 reads sound data stored in the ROM 108, and sends the read sound data to the speaker drive circuit 122 via the input-output bus 104. This enables the speaker 41 to generate predetermined sound effects.

The hopper drive circuit 124 for driving the hopper 44 is also connected to the input-output bus 104. If a cash-out signal from the cash-out switch 26 is inputted, the CPU 106 outputs a drive signal to the hopper drive circuit 124 via the input-output bus 104. This enables the hopper 44 to payout a number of coins corresponding to the number credits remaining at that time, which is stored in a predetermined memory area of RAM 110.

The display/input controller 140 is also connected to the input-output bus 104. The CPU 106 generates an image display instruction according to the game state and game result, and outputs the generated image display instructions to the display/input controller 140 via the input-output bus 104. If the image display instructions are inputted from the CPU 106, the display/input controller 140 generates a drive signal for driving the liquid crystal display 30 based on the inputted image display instruction, and outputs the generated drive signal to the liquid crystal display 30. This enables a predetermined image to be displayed on the transparent liquid crystal panel 34 of the liquid crystal display 30.

The touch panel control circuit 160 is also connected to the input-output bus 104. The touch panel control circuit 160 sends, as an input signal, an inputted signal to the touch panel 32 on the liquid crystal display 30 to the CPU 106 via the input-output bus 144.

The voice recognition circuit 190 is also connected to the input-output bus 104. The voice recognition circuit 190 supplies received voice data to a voice recognition unit 191. The voice recognition unit 191, which is a known voice recognition unit, converts the supplied voice data to character data.

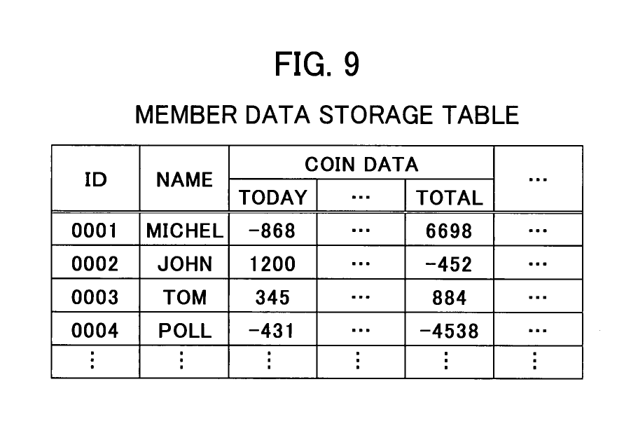

FIG. 9 shows a member data storage table to be stored in the management server 500. In this table, the IDs of the players are stored in association with the names of the players. Furthermore, various data such as coin data are stored in association with the respective players. The coin data have data of “today,” “yesterday,” “the day before yesterday,” and the like, and the sum of these data are stored as “the total.” For example, the ID “0001” associated with “Michel” indicates that “−868” in today's coin data, and “6698” in the current total coin data.

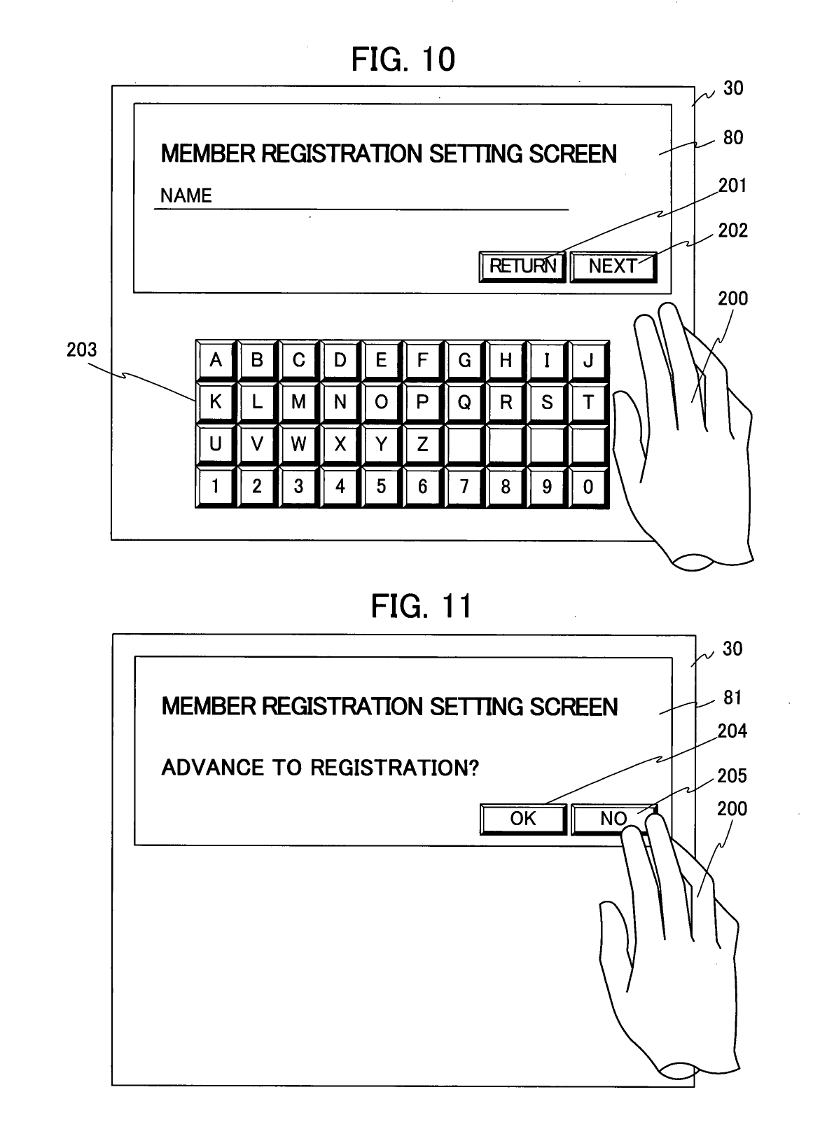

FIGS. 10 and 11 are display examples displayed on the liquid crystal display 30 at the time of member registration process to be described later in step S14 in FIG. 18.

Referring to FIG. 10, a small window 80 is displayed on an upper part of the liquid crystal display 30, and a panel 203 is displayed below the small window 80. A panel 201 and a panel 202 are displayed on the small window 80. The panel 203 is provided with the Latin letters “A” to “Z” and numerals “0” to “9.”

“Member registration screen,” “name” and the like are displayed so that the player's name can be registered. The player can make the member registration by touching the panels 201 to 203 by player hand 200. That is, the touch of the panel 203 by the hand 200 enables a Latin letter or the like corresponding to the touched panel to be displayed in a “name” site of the small window 80. The touch of the panel 201 by the hand 200 enables the procedure to be moved to the next member registration setting screen. The touch of the panel 202 by the hand 200 enables the procedure to be moved to the preceding member registration setting screen.

Referring to FIG. 11, the small window 81 is displayed on an upper part of the liquid crystal display 30, and panel 204 and 205 are displayed on the small window 81.

“Member registration setting screen,” “advance to registration?” and the like are displayed on the small window 81. The touch of a panel 204 by the hand 200 enables the member registration to be performed based on the inputted data or the like, as in FIG. 10. The touch of a panel 205 by the hand 200 does not enable member registration to be performed.

Thus, the present invention can increase the convenience of the registration procedure because the member registration can be performed on the touch panel 32 provided in the liquid crystal display 30 of the slot machine 13. The present invention can also increase convenience when identifying the member because the player's cellular phone is used to confirm the serial number identifying the player.

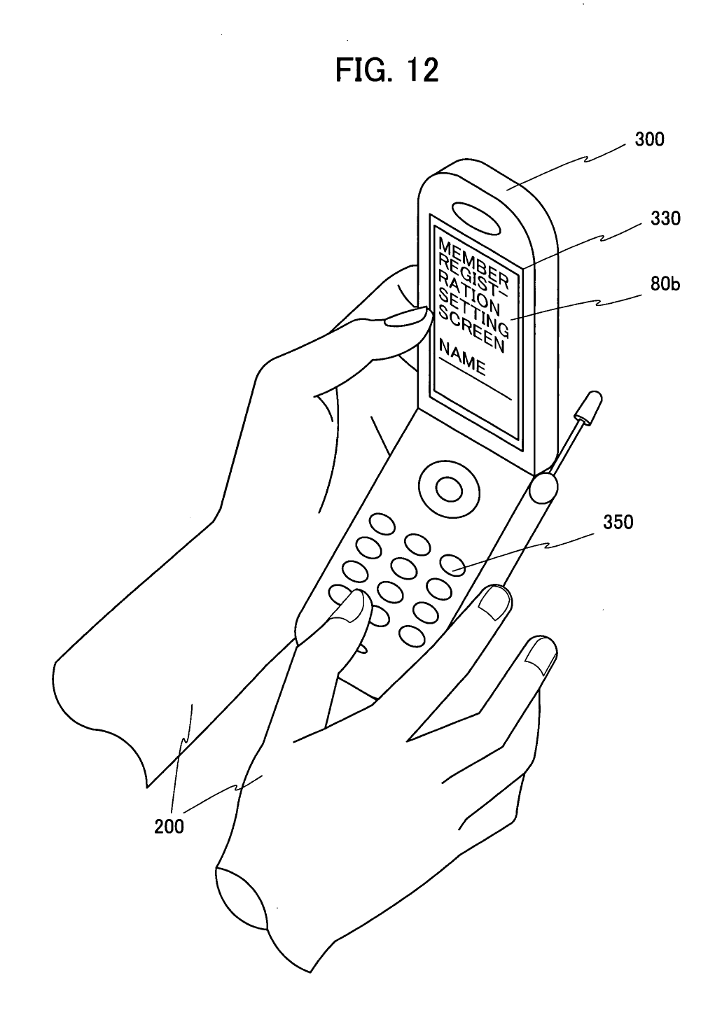

In an alternative, as shown in FIG. 12, the member registration may be performed by the player's cellular phone 300 without using the touch panel 32 of the slot machine 13.

Specifically, when the slot machine 13 and cellular phone 300 are connected to each other via the external connecting terminal 170, a small window 80b is displayed on a display 330 of the cellular phone 300. Data necessary for member registration can be inputted by the operation of an operating part 350 of the cellular phone 300 by the hand 200.

Thus, the present invention can increase the convenience of the registration procedure because the member registration is executable by the cellular phone 300 the player is accustomed to using.

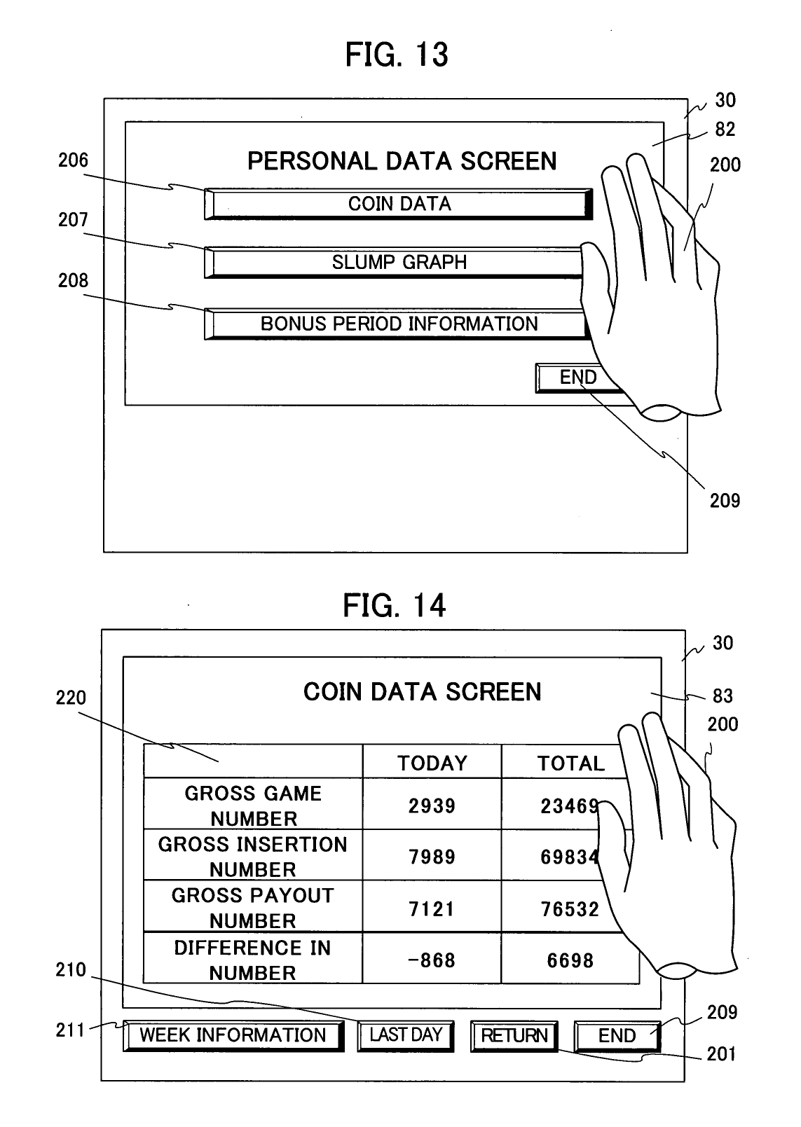

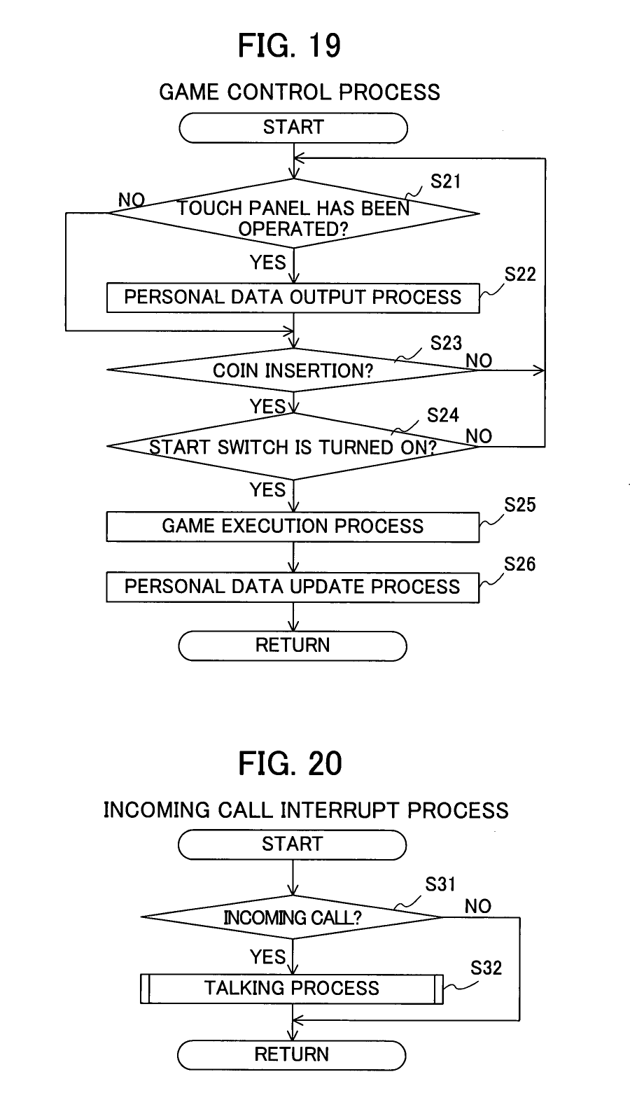

FIGS. 13 and 14 show display examples displayed on the liquid crystal display 30 at the time of personal data output process to be described later in step S22 in FIG. 19.

Referring to FIG. 13, a small window 82 is displayed on an upper part of the liquid crystal display 30. Panels 206 to 209 are displayed on the small window 82.

“Personal data screen” is displayed on the small window 82. The touch of the panels 206 to 208 by the hand 200 enables various data to be displayed on the liquid crystal display 30. The various data are data stored in the above-mentioned member data storage table in FIG. 9. By touching the panel 209 with the hand 200, a screen corresponding to the basic game performed by the slot machine 13 can be displayed on the liquid crystal display 30.

FIG. 14 shows a display example displayed on the liquid crystal display 30 when the panel 206 is touched in FIG. 13.

Referring to FIG. 14, a small window 83 is displayed on an upper part of the liquid crystal display 30. Panels 201 and panels 209 to 211 are displayed on the small window 83.

“Coin data screen” and coin data 220 are displayed on the small window 83. The player can see from the today's data in the coin data 220 displayed on the liquid crystal display 30 that 2939 games were performed, 7989 coins were inserted, 7121 coins were paid out, and as the result, 868 coins were lost. The player can also see from the total data that 23469 games were performed, 69834 coins were inserted, 76532 coins were paid out, and as the result, 6698 coins were accumulated.

Here, by touching the panel 201 with the hand 200, the preceding screen (refer to FIG. 13) can be displayed on the liquid crystal display 30. By touching the panel 209 with the hand 200, a screen corresponding to the basic game performed on the slot machine 13 can be displayed on the liquid crystal display 30. By touching the panel 210 with the hand 200, the player's previous coin data can be displayed on the liquid crystal display 30. By touching the panel 211 with the hand 200, the player's coin data of the previous week can be displayed on the liquid crystal display 30.

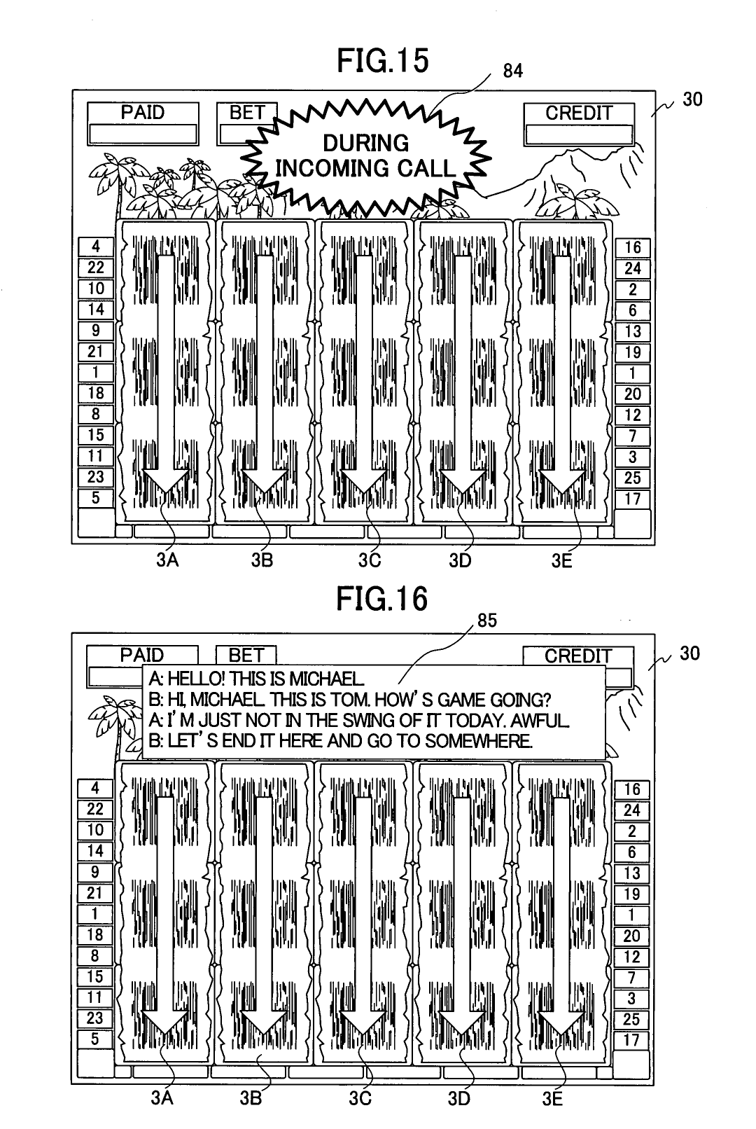

FIG. 15 shows a display example displayed on the liquid crystal display 30 if there occurs an incoming call to be described later in step S31 in FIG. 20.

Referring to FIG. 15, a small window 84 is displayed on an upper part of the liquid crystal display 30, and “during incoming call” is displayed on the small window 84. In FIG. 15, a screen displayed in the basic game is displayed on the liquid crystal display 30, and the mechanical reels 3A to 3E are displayed while in a rotating state. That is, the small window 84 can be displayed on the liquid crystal display 30 in the course of the basic game.

In this manner the displays enable the player to become aware of any incoming call, even if the surroundings are noisy in a gaming center, such as a casino. In particular, the player does not feel distracted because the ongoing basic game can be displayed without any discontinuation of the small window 84.

FIG. 16 shows a display example displayed on the liquid crystal display 30 during the talking process to be described later in step S32 in FIG. 20. This shows a display example when the player is talking with the caller after receiving an incoming call in FIG. 15.

Referring to FIG. 16, a small window 85 is displayed on an upper part of the liquid crystal display 30, and dialogs between the player (A) and the caller (B) are displayed on the small window 85. At this time, on the liquid crystal display 30, a screen displayed in the basic game can be displayed, and the mechanical reels 3A to 3E can be displayed while a rotating state. That is, the small window 85 can be displayed on the liquid crystal display 30 in the course of the basic game. The conversation is performed with the headphones 180, with the microphone equipped in the slot machine 13.

In this manner the displays enable the player to communicate even if the surroundings are noisy in the gaming center, such as a casino. In particular, the player can continue the basic game while talking, because the ongoing basic game can be displayed without any discontinuation on the small window 85.

FIG. 17 is a flow chart showing the main process flow of the slot machine 13 executed by the controller 100 of the slot machine 13.

In the following, it is assumed that the slot machine 13 is activated in advance, and the variables used in the CPU 106 are initialized to predetermined values, so that the slot machine 13 is in a normal operating state.

The CPU 106 performs a player discrimination process described in FIG. 18 (step S1), and then moves the procedure to step S2. In step S2, the CPU 106 performs a game control process described later in FIG. 19. The CPU 106 then terminates the present routine.

FIG. 18 is a flow chart showing the player discrimination process flow that is a subroutine of a main process in FIG. 17.

The CPU 106 decides the presence or absence of a connection to a cellular phone (step S11). Specifically, the CPU 106 decides whether the slot machine 13 and the cellular phone 300 are connected to each other via the external connecting terminal 170. If connected (if the result is “YES” in step S11), the CPU 106 moves the procedure to step S12. If not connected (if the result is “NO” in step S11), the CPU 106 terminates the present subroutine.

In step S12, the CPU 106 performs an ID discriminating process, in particular, reading a discrete serial number of each cellular phone 300 via the external connecting terminal 170. The CPU 106 then moves the procedure to step S13.

In step S13, the CPU 106 decides whether the discriminated ID is already registered or not. Specifically, the CPU 106 decides whether the ID discriminated in step S12 is already registered or not by referring to, via the interface circuit 111 for communication, the member data storage table (FIG. 9) stored in the management server 500. If it is the registered ID (if the result is “YES” in step S13), the CPU 106 moves the procedure to step S16. If not the registered ID (if the result is “NO” in step S13), it moves the procedure to step S14.

In step S14, the CPU 106 performs a member registration process. Specifically, the CPU 106 registers the player's personal data by displaying a member registration setting screen on the liquid crystal display 30 via the display/input controller 140 (refer to FIGS. 10 and 11), and receiving an operation signal from the player via the touch panel control circuit 160 or the like. The CPU 106 then moves the procedure to step S15.

In step S15, the CPU 106 performs a registered data sending process. Specifically, the CPU 106 sends the personal data registered in step S14 to the management server 500 via the interface circuit 111 for communication. The CPU 106 then moves the procedure to step S16.

In step S16, the CPU 106 performs a personal data receiving process. Specifically, the CPU 106 receives personal data corresponding to the ID discriminated in step S12 from the management server 500 via the interface circuit 111 for communication, and stores it in a predetermined area in the RAM 110. The CPU 106 then terminates the present subroutine.

FIG. 19 is a flow chart showing the flow of a game control process that is a subroutine of the main process in FIG. 17.

In the following, it is assumed that the slot machine 13 is connected to the cellular phone 300 via the external connecting terminal 170.

The CPU 106 decides whether the touch panel 32 has been operated or not (step S21). Specifically, the CPU 106 decides via the touch panel control circuit 160 whether the touch panel 32 has been operated or not. If operated (if the result is “YES” in step S21), the CPU 106 moves the procedure to step S22. If not operated (if the result is “NO” in step S21), it moves the procedure to step S23.

In step S22, the CPU 106 performs a personal data output process. Specifically, the CPU 106 displays on the liquid crystal display 30 via the display/input controller 140 a personal data screen (refer to FIGS. 13 and 14) based on the above-described personal data received in step S16 in FIG. 18. Thus, if no basic game is performed in the slot machine 13, the personal data screen can be displayed on the liquid crystal display 30 when the touch panel 32 is operated. The CPU 106 then moves the procedure to step S23.

In step S23, the CPU 106 decides whether a certain number of coins have been inserted or not. Specifically, the CPU 106 decides via the interface circuit group 102 whether the BET switch 23 or the spin-repeat-bet switch 24 has been operated or not, or decides via the coin sensor 43 whether a certain number of coins have been inserted or not. If inserted (if the result is “YES” in step S23), the CPU 106 moves the procedure to step S24. If not inserted (if the result is “NO” in step S23, it moves the procedure to step S21.

In step S24, the CPU 106 decides whether the start switch is turned on or not. Specifically, the CPU 106 decides via the interface circuit group 102 whether the spin-repeat-bet switch 24 or the start switch 25 has been operated or not. If the start switch is turned on (if the result is “YES” in step S24, the CPU 106 moves the procedure to step S25. If the start switch is not turned on (if the result is “NO” in step S24, the CPU 106 moves the procedure to step S21.

In step S25, the CPU 106 performs a game execution process. Specifically, the CPU 106 instructs the random number generator 112 to generate a random number in order to decide a combination of symbols in the basic game, and also instructs the motor drive circuit 120 to rotate and then stop the mechanical reels 3A to 3E. If the combination of symbols is a predetermined combination, the CPU 106 instructs the hopper drive circuit 124 to award a prize via the hopper 44. The CPU 106 then moves the procedure to step S26.

In step S26, the CPU 106 performs a personal data update process. That is, the CPU 106 updates the personal data from the number of coins inserted in step S23, and the result of the game execution process in step S25. The CPU 106 then terminates the present subroutine.

FIG. 20 is a flow chart showing the flow of an incoming call interrupt process.

In the following, it is assumed that the slot machine 13 is connected to the cellular phone 300 via the external connecting terminal 170.

The CPU 106 decides whether there is an incoming call or not (step S31). Specifically, the CPU 106 decides via the external connecting terminal 170 whether there is an incoming call signal received by the cellular phone 300 is received via the external connecting terminal 170. If decided there is the incoming call signal (if the result is “YES” in step S31), the CPU 106 moves the procedure to step S32. If not decided so (if the result is “NO” in step S31), it terminates the present routine. If received an incoming call signal, the CPU 106 instructs the display/input controller 140 to display a predetermined display on the liquid crystal display 30 (refer to FIG. 15).

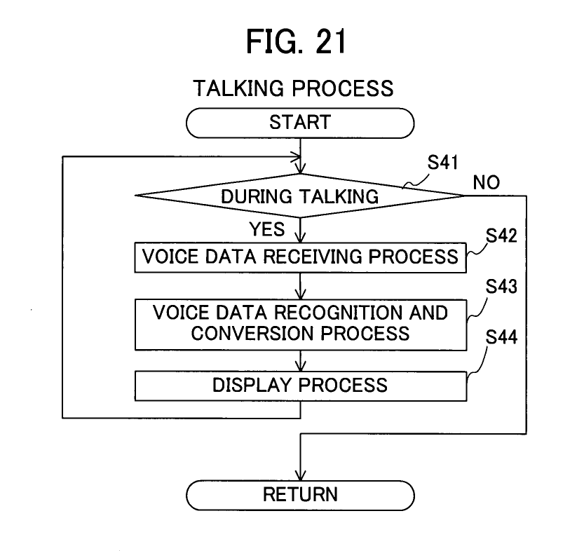

In step S32, the CPU 106 performs a talking process to be described later in FIG. 21, and then terminates the present routine.

FIG. 21 is a flow chart showing the communication process flow, which is a subroutine of the incoming call interrupt process in FIG. 20.

The CPU 106 decides whether it is in the middle of talking (step S41). If so (if the result is “YES” in step S41), the CPU 106 moves the procedure to step S42. If not (if the result is “NO” in step S41), it terminates the present subroutine.

In step S42, the CPU 106 performs a voice data receiving process. Specifically, the CPU 106 receives the voice data of the player from the player's voice received by the headphones 180 with the microphone, and also receives the voice data of the caller by receiving via the external connecting terminal 170 the voice data received by the cellular phone 300. In this case, if voice data of the caller is received, the CPU 106 outputs the voice to the headphones of the headphone 180 with the microphone. The CPU 106 then moves the procedure to step S43.

In step S43, the CPU 106 performs a voice data recognition and conversion process. Specifically, the CPU 106 supplies the voice data received in step S42 to the voice recognition unit 191 via the voice recognition circuit 190. The voice recognition unit 191 converts the supplied voice data to character data. The CPU 106 then moves the procedure to step S44.

In step S44, the CPU 106 performs a display process. Specifically, the CPU 106 supplies the character data obtained in step S43 to the display/input controller 140. Based on the supplied character data, the display/input controller 140 performs a predetermined display on the liquid crystal display 30 (refer to FIG. 16). The CPU 106 then returns the procedure to step S41.

While preferred embodiments of the slot machine of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

For example, the external connecting terminal 170 may be a connecting means other than the cellular phone connecting holder 170a, the cellular phone connecting cable 170b, or the card slot 170c.

In the description of the foregoing embodiment, though the slot machine 13 updates the personal data (step S26 in FIG. 19), the slot machine 13 may send the result of the game execution process to the management server 500 so that the management server 500 can update the personal data.

What is claimed is:

1. A slot machine connected so as to establish communication with a management server storing data of a plurality of players, the slot machine comprising:
a display displaying the data;
a connecting terminal connectable to a cellular phone of a player; and
a game controller identifying the player by a connection to the cellular phone via the connecting terminal, and receiving data associated with the identified player from the management server, and then displaying the received data on the display.

2. The slot machine according to claim 1, wherein
the display displays an instruction input image corresponding to an instruction inputted by a player;
the slot machine further includes a touch panel disposed on a front surface of the display, the touch panel capable of detecting contact of the player and outputting a detection signal indicating a contact position when contact is detected; and
the game controller controls a representation on the display based on an instruction associated with the instruction input image, when a detection signal indicating a contact position corresponding to a display position of the instruction input image on the display is outputted from the touch panel.

3. The slot machine according to claim 1, wherein
the cellular phone has an operating part accepting an input from a player; and
the game controller controls the representation on the display based on an operation of the operating part by the player.

4. The slot machine according to claim 1, wherein the game controller accepts voice data input from the player via the connected cellular phone, and recognizes the accepted voice data according to the voice data input, and converts the recognized voice data to character data, and then displays the converted character data on the display.

5. A slot machine connected so as to establish communication with a management server storing data of a plurality of players, the slot machine comprising:
a display displaying the data;
an insertion slot into which an individual identification card of a player can be inserted; and
a game controller identifying the player by an insertion of the individual identification card into the insertion, and receiving data associated with the identified player from the management server, and then displaying the received data on the display.

6. The slot machine according to claim 5 wherein the individual identification card is an SIM card.

7. A method of advancing a game by a game controller in a slot machine connected so as to establish communication with a management server storing data of a plurality of players, the slot machine including a display displaying the data and a connecting terminal connectable to a cellular phone of a player, the method comprising the steps of:
identifying the player by a connection with a cellular phone via the connecting terminal; and
receiving data associated with an identified player from the management server.

8. The method according to claim 7, wherein
the slot machine further includes a touch panel disposed on a front surface of the display, the touch panel capable of detecting contact of a player and outputting a detection signal indicating a contact position when contact is detected; and
the game controller includes the steps of:
(a) displaying on the display an instruction input image associated with an instruction inputted by a player;
(b) outputting a detection signal indicating a contact position corresponding to a display position of the instruction input image in response to contact with the touch panel by the player; and
(c) controlling a representation on the display based on the detection signal.

9. The method according to claim 7, wherein
the cellular phone has an operating part accepting an input from a player; and
the game controller includes the step of controlling a representation on the display based on operation of the operating part by the player.

10. The method according to claim 7, wherein
the game controller includes the steps of:
accepting voice data input from the player via the connected cellular phone;
recognizing accepted voice data according to the input of the voice data;
converting the recognized voice data to character data; and
displaying the converted character data on the display.

11. A method in which a game controller advances a game in a slot machine, connected so as to establish communication with a management server storing data of a plurality of players, the slot machine including a display displaying the data and an insertion slot into which an individual card of a player can be inserted, the method comprising the steps of:
identifying a player by insertion of the individual identification card into the insertion slot;
receiving data associated with an identified player from the management server; and
displaying the data received on the display.

12. The method according to claim 11, wherein the individual identification card is an SIM card.
